(19) United States
(12) Patent Application Publication
(10) Pub. No.: US 2025/0342514 A1
(43) Pub. Date: Nov. 6, 2025

(54) STORAGE ARRAY DRIVE RECOMMENDATION TAILORED TO WORKLOAD CHARACTERISTICS

(71) Applicant: Dell Products L.P., Round Rock, TX (US)

(72) Inventors: Ramesh Doddaiah, Westborough, MA (US); Arieh Don, Newton, MA (US); Tomer Shachar, Beer-Sheva (IL)

(21) Appl. No.: 18/655,459

(22) Filed: May 6, 2024

(51) Int. Cl. G06Q 30/0601

(52) U.S. Cl. CPC G06Q 30/0631

(57) ABSTRACT

Architectures and techniques are described that can provide a recommendation for a new drive that is to be added to a storage array. The new drive can be a replacement drive that replaces a failed drive of the storage array or one or more additional drives that expand the storage array. Advantageously, the recommended drive can be specifically tailored to a workload under which the new drive is expected to operate once installed in the storage array. For example, workload metrics or conditions for the failed drive or the storage array can be examined. In response, the recommended drive can be one that is determined to have improved durability (or another characteristic) under the expected service conditions for the new or replacement drive.

### BACKGROUND

Storage arrays play a crucial role for virtually all businesses that rely on modern data centers by providing scalable, reliable, and high-performance storage solutions to meet the growing demands of data-intensive applications and workloads. A storage array, also known as a disk array or storage system, is a centralized storage solution that consists of multiple storage devices, referred to herein as drives, that are organized into a single unit. These drives are typically connected to a storage controller or array controller, which manages data storage, retrieval, and access operations. Storage arrays are designed to provide scalable and reliable storage for storing large amounts of data in enterprise environments. Storage arrays offer features such as data redundancy, high availability, and data protection mechanisms to ensure the integrity and availability of stored data.

### BRIEF DESCRIPTION OF THE DRAWINGS

Numerous aspects, embodiments, objects, and advantages of the present embodiments will be apparent upon consideration of the following detailed description, taken in conjunction with the accompanying drawings, in which like reference characters refer to like parts throughout, and in which:

FIG. 1 shows a schematic block diagram illustrating an example representation of a storage array from along with certain aspects from the perspective of a provider or vendor of the storage array in accordance with certain embodiments of this disclosure;

FIG. 2 depicts a schematic block diagram illustrating an example device that can generate a recommendation for a replacement drive to replace a failed drive of a storage array based on workload characteristics of the failed drive in accordance with certain embodiments of this disclosure;

FIG. 3 depicts a tabular diagram illustrating an example of the service history data that can be received from the telemetry data store in accordance with certain embodiments of this disclosure;

FIG. 4 depicts a schematic block diagram illustrating various examples of the workload characteristics in accordance with certain embodiments of this disclosure;

FIG. 5 depicts, a schematic block diagram illustrating additional elements or aspect of the example device that can generate the recommendation and can further determine the workload characteristics in accordance with certain embodiments of this disclosure;

FIG. 6 depicts a schematic block diagram illustrating an example machine learning model that can determine or identify at least one of suitable workload characteristics, the prominent workload characteristics, or the recommendation data in accordance with certain embodiments of this disclosure;

FIG. 7 depicts a schematic block diagram illustrating the example device generating a recommendation for a new drive to be added to a storage array based on workload characteristics of the storage array in accordance with certain embodiments of this disclosure;

FIG. 8 illustrates an example method that can generate a recommendation for a replacement drive to replace a failed drive of a storage array based on workload characteristics of the failed drive in accordance with certain embodiments of this disclosure;

FIG. 9 illustrates an example method that can provide for additional elements or functionality relating to generating the recommendation for a replacement drive to replace a failed drive of a storage array based on workload characteristics of the failed drive in accordance with certain embodiments of this disclosure;

FIG. 10 illustrates a block diagram of an example distributed file storage system that employs tiered cloud storage in accordance with certain embodiments of this disclosure; and

FIG. 11 illustrates an example block diagram of a computer operable to execute certain embodiments of this disclosure.

### DETAILED DESCRIPTION

### Overview

The disclosed subject matter is now described with reference to the drawings, wherein like reference numerals are used to refer to like elements throughout. In the following description, for purposes of explanation, numerous specific details are set forth in order to provide a thorough understanding of the disclosed subject matter. It may be evident, however, that the disclosed subject matter may be practiced without these specific details. In other instances, well-known structures and devices are shown in block diagram form in order to facilitate describing the disclosed subject matter.

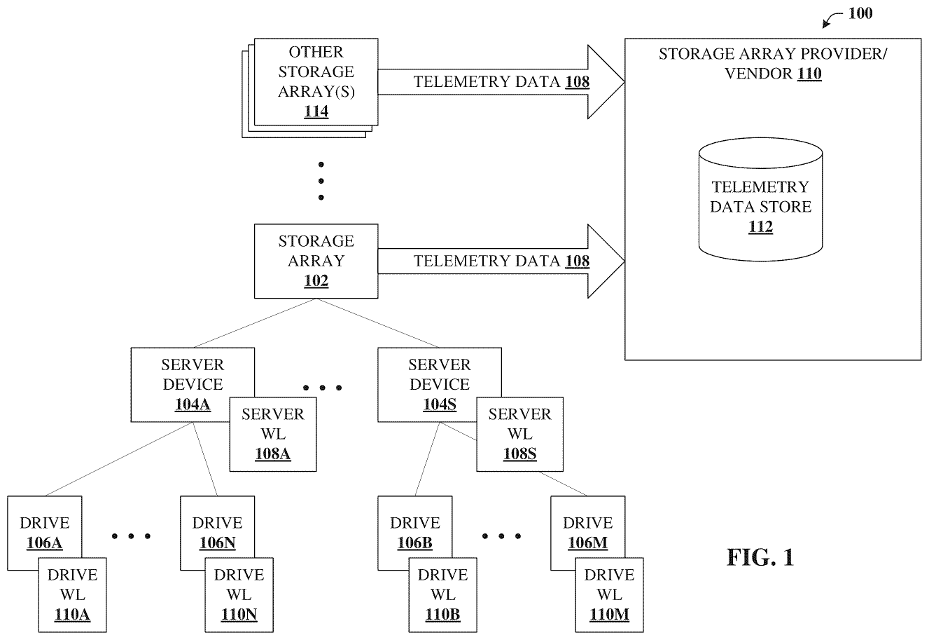

To provide additional context, consider FIG. 1. FIG. 1 shows a schematic block diagram 100 illustrating an example representation of a storage array from along with certain aspects from the perspective of a provider or vendor of the storage array in accordance with certain embodiments of this disclosure.

In that regard, diagram 100 illustrates an example storage array 102 that may be designed, installed, managed, monitored, or maintained by a storage array provider or vendor, referred to herein as storage array vendor 110. Storage array 102 can be any suitable type of storage array, including, for example, a network-attached storage (NAS) system, a storage area network (SAN) system, or another suitable type of system.

In more detail, NAS systems typically connect to a local area network (LAN) and provide file-level access to data over a network protocol such as Network File System (NFS) or Server Message Block (SMB). NAS systems are designed for easy file sharing and centralized storage management, and are commonly used for file serving, backups, and multimedia storage. SAN systems typically rely on a dedicated network infrastructure that connects multiple storage devices (such as disk arrays or tape libraries) to multiple servers or hosts. SAN systems use block-level protocols such as Fibre Channel (FC), iSCSI, or Fibre Channel over Ethernet (FCOE) to provide high-speed, low-latency access to shared storage resources. SANs are commonly used in enterprise environments for high-performance applications, virtualization, and centralized storage management. It is understood that the disclosed techniques can be applicable to any type of storage array 102, including SAN systems, NAS systems, or another suitable type of storage array system.

Storage array 102 can comprise any suitable number of server devices 104, illustrated as server devices 104A-104S, where S is a whole number. Each server device 104 can comprise any suitable number of drives 106, illustrated here as drives 106A-106N of server device 104A, and drives 106B-106M of server device 104S, where N and M are whole numbers. In accordance with the disclosed techniques, drives 106 can be any suitable type of drive, including a hard disk drive (HDD), a solid state drive (SSD), or another suitable type of drive. In more detail, an HDD comprises magnetic disk(s) or platters that spin, allowing data to be accessed via a moving arm or cantilever with a read/write head. An SSD comprises memory chips (e.g., flash memory chips) that store data and allow data access without moving parts.

A given customer (e.g., a business entity that relies on a data center or the like) of storage array vendor 110 can have multiple storage arrays 102. Furthermore, each different customer of storage array vendor 110 can have independent, substantially unique respective storage arrays 102. Thus, for a given storage array 102, each server device 104 can have a different and potentially unique server workload 108, illustrated here as server workloads 108A (e.g., for server device 104A) and 108S (e.g., for server device 104S).

Likewise, each drive 106 within a given server device 104 can have a different and potentially unique drive workload 110, illustrated here as respective drive workloads 110A-110N and 110B-110M. However, a given drive workload 110, as well as other statistics, analytics, measurements, or the like, can be provided to storage array vendor 110 via telemetry data 108. By way of example, telemetry data 108 can comprise information or statistics from each respective drive 106 such as a number of reads and/or writes performed as well as a type of read or write performed, which is further detailed infra.

As shown, telemetry data 108 can be received from the example storage array 102, as well as from other storage arrays 114, which could be a different storage array associated with the same customer or a different storage array associated with a different customer. All or a portion of such telemetry data 108 can be stored to telemetry data store 112, where the telemetry data 108 can be aggregated, analyzed, or processed in any suitable manner.

As previously noted, different customers of storage array vendor 110 can have distinct workload profiles for server devices 104 and/or associated drives 106. For example, a customer with a business directed to banking transactions or e-commerce transactions may have an entirely different workload profile than one directed to streaming services.

Such becomes more significant because the inventors have observed that a given workload profile for a drive 106 (e.g., drive workload 110) can be a significant factor affecting the lifespan of that particular drive 106. The inventors have further observed that different drive types (e.g., drives of different manufacturers, models, sizes, . . . ) have different characteristics that cause the different drive types to exhibit different durability measures (or other operational characteristics) that vary as a function of drive workload 110.

Based on the above observations, when a given drive 106 of storage array 102 fails or otherwise requires replacing, or when storage array 102 is expanded by adding new drives, the newly added drive(s) can be intelligently recommended or selected based on an expected drive workload 110 that the new drive expected to handle. Selection of the type of the new drive can therefore be tailored to a specific workload profile, which can be significantly more advantageous than selecting the drive type substantially at random (e.g., what a service technician happened to bring to the site) or based on testing numbers provided by the manufacturer.

In more detail, drive manufacturers commonly perform extensive tests on drives and publish certain results such as a mean time between failure (MTBF) rating, and/or a mean time to failure (MTTF) rating, which provide a general estimate of the life expectancy of a drive. Moreover, storage array vendors 110 might also perform tests, potentially even more extensive than the manufacturer, in order to certify a particular drive for use. Thus, one naïve approach might be to simply select a replacement drive that has the best MTBF or MTTF rating.

Unfortunately, such an approach is not likely to give superior results. MTBF or MTTF ratings are only representative of a given drive's durability and/or longevity for the specific workload that was used in the test. Thus, MTBF or MTTF ratings are not generally representative of the realistic expected usage or life of a drive that operates according to a different workload profile. As noted above, a given drive workload 110A is expected to vary, potentially dramatically so, from a different drive workload 110 relating to a drive in other storage array 114 (e.g., associated with a different customer), and may even significantly differ from other drive workloads 110 within the same storage array 102.

MTBF or MTTF ratings do not take into consideration any real application drive usage model such as read versus write utilization, sequential versus random workloads, large block versus small block workloads, compressed versus uncompressed versus encrypted writes, write acceleration, write efficiency and so forth. Hence, even though MTBF, MTTF, potentially as well as terabytes written (TBW), drive writes per day (DWPD), wear leveling statistics, garbage collection statistics, and so on are generally published by each manufacturer, such metrics are generated via workloads having generic or simple characteristics such as sequential writes, a set number of writes, or the like.

Hence, following the naïve approach mentioned above, in which a new drive is selected based on published criterion, certain issues can arise. For example, once a drive (e.g., drive 106) of a particular model and size from a particular manufacturer fails in an array (e.g., storage array 102) it is likely that the failed drive will be replaced by the same model or another model from a different manufacturer that was selected due to published criterion. Such can lead to more frequent failures in the future because the selected model may not be the best replacement for the workload profile for which it will operate, even if the selected model performed quite well on the generic workloads used for testing.

Rather, each individual customer array might be slightly different based on the domain, usage and business needs, and so forth. As noted previously, customer workloads can be a major factor affecting the life span of drives 106. Manufacturers only evaluate the life of drives 106 on generic and/or standard workloads and publish those results. Such results might not be representative of actual workloads in the field as customers' internal (e.g., local and remote replication, defragmentation, redundant array of independent disks (RAID), data migration, . . . ) and external (e.g., host input/output (IO) transactions, IO sizes, encrypted vs. compressed vs. uncompressed data, . . . ) workloads likely use a given drive 106 in ways that differ from the manufacturer testing and test results.

When a customer adds a new drive to storage array 102 (e.g., due to expansion or to replace a failed drive) it may not be clear which model and manufacturer of a new drive will better fit the customer's specific array workload. Published testing values or ratings may have little value as those testing results may not cover the unique workloads (e.g., server workload 108, drive workload 110) run on the particular storage array 102 in which the new drive will be installed.

The disclosed subject matter can mitigate these and other difficulties by recommending a new drive type (e.g., make or manufacturer, model, size, . . . ) that is determined to provide increased lifespan or durability (or another specified metric) that is tailored to the unique workload of the particular storage array in which the drive will be installed. Thus, the disclosed techniques can provide a significant technological improvement in the domain of storage arrays by, e.g., increasing the operational life of individual drives 106 within storage array 102. Hence, drive failures per unit of time can be reduced, which can reduce costs to the customer, reduce down time resulting from failed drives, improve data center or storage array sustainability metrics, and so on.

### Example Systems

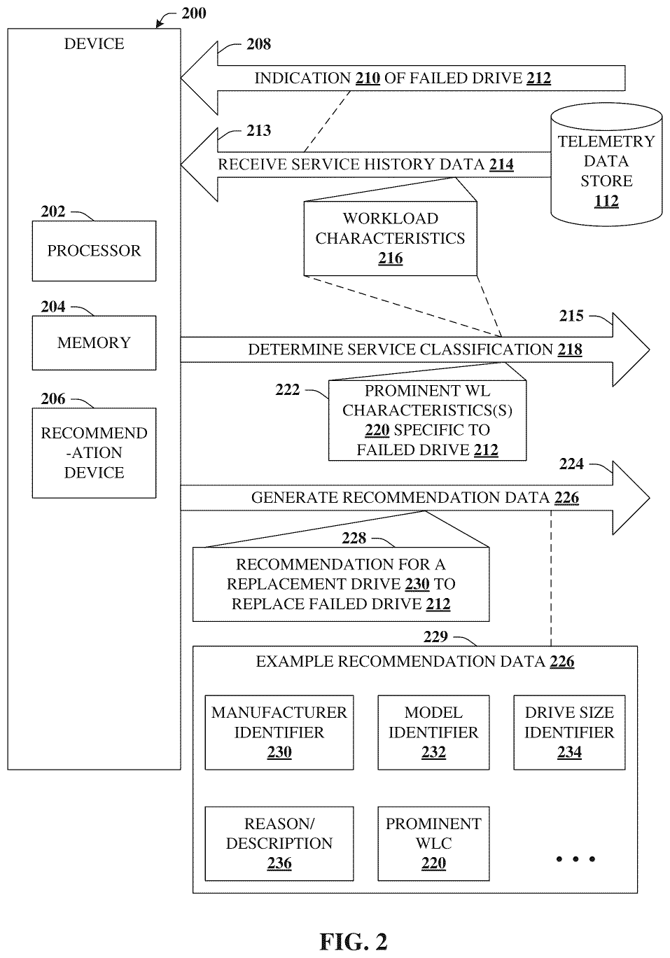

With reference now to FIG. 2, a schematic block diagram is depicted illustrating an example device 200 that can generate a recommendation for a replacement drive to replace a failed drive of a storage array based on workload characteristics of the failed drive in accordance with certain embodiments of this disclosure. In some embodiments, device 200 can be communicatively coupled to or integrated with a telemetry system or other system associated with a storage array provider or vendor, such as a device or system of storage array provider or vendor 110 of FIG. 1. In some embodiments, all or a portion of device 200 can be coupled to or integrated with a device of a storage array such as storage array 102 or another device associated with a customer of storage array vendor 110.

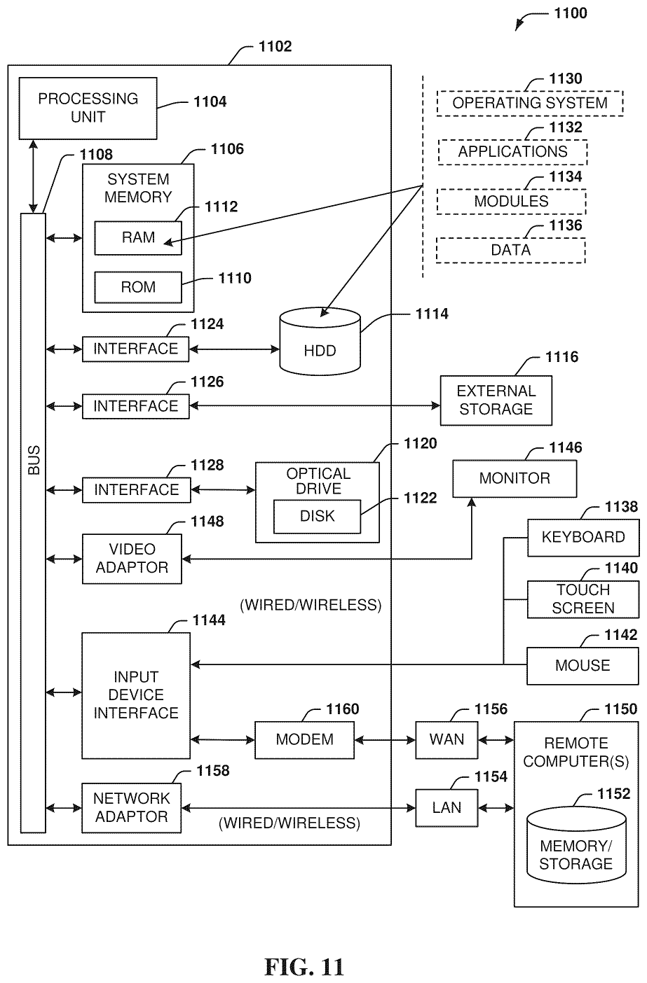

Device 200 can comprise at least one processor 202 that, potentially along with recommendation device 206, can be specifically configured to perform functions associated with determining drive characteristics and/or making recommendations for new drives placed in a storage array. Device 200 can also comprise at least one memory 204 that stores executable instructions that, when executed by the at least one processor 202, can facilitate performance of operations. Processor(s) 202 can be a hardware processor having structural elements known to exist in connection with processing units or circuits, with various operations of processor 202 being represented by functional elements shown in the drawings herein that can require special-purpose instructions, for example, stored in memory 204 and/or recommendation device 206. Along with these special-purpose instructions, processor 202 and/or recommendation device 206 can be a special-purpose device. Further examples of the memory 204 and processor 202 can be found with reference to FIG. 11. It is to be appreciated that device 200 or computer 1102 can represent a server device or a client device of a network or data services platform and computer 1102 can be used in connection with implementing one or more of the systems, devices, or components shown and described in connection with FIG. 2 and other figures disclosed herein.

As illustrated at reference numeral 208, device 200 can receive indication 210. Indication 210 can identify (e.g., via a unique device identifier) a failed drive 212. Failed drive 212 can be representative of a drive (e.g., drive 106) of a storage array (e.g., storage array 102) that has failed or otherwise is to be replaced within the storage array with a new drive.

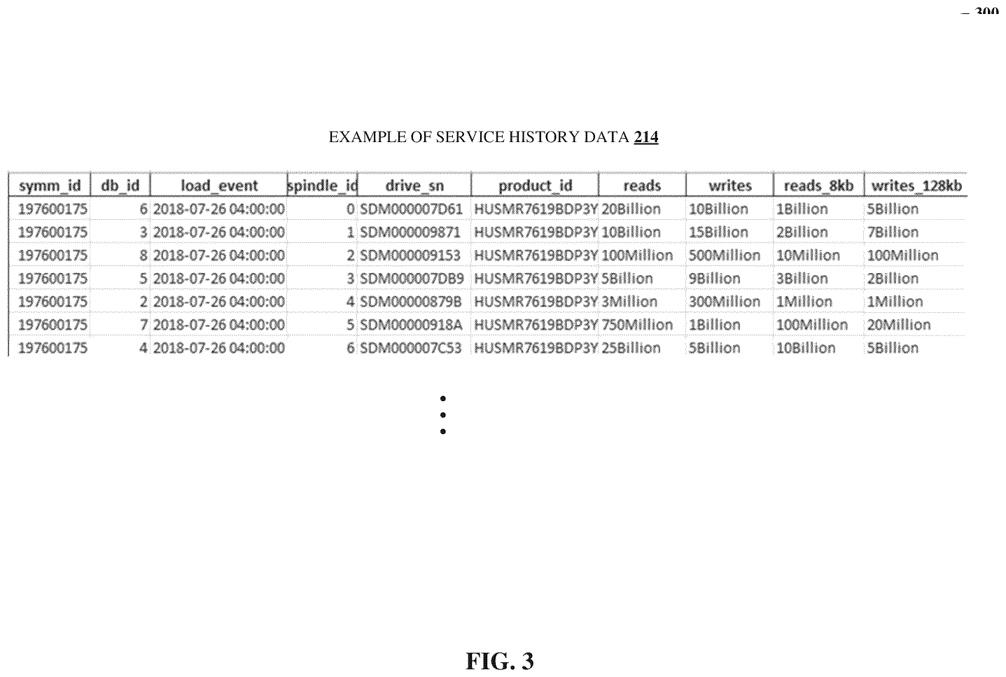

At reference numeral 213, in response to indication 210, device 200 can receive service history data 214, for example, from telemetry data store 112. In some embodiments, device 200 can request service history data 214 based on the device identifier included in indication 210. Service history data 214 can, in some embodiments, be specific to failed drive 212. In some embodiments, service history data 214 can include information relating to all or a portion of the drives in an associated storage array. A non-limiting, but representative example of service history data 214 can be found with reference to FIG. 3, which will be further discussed shortly.

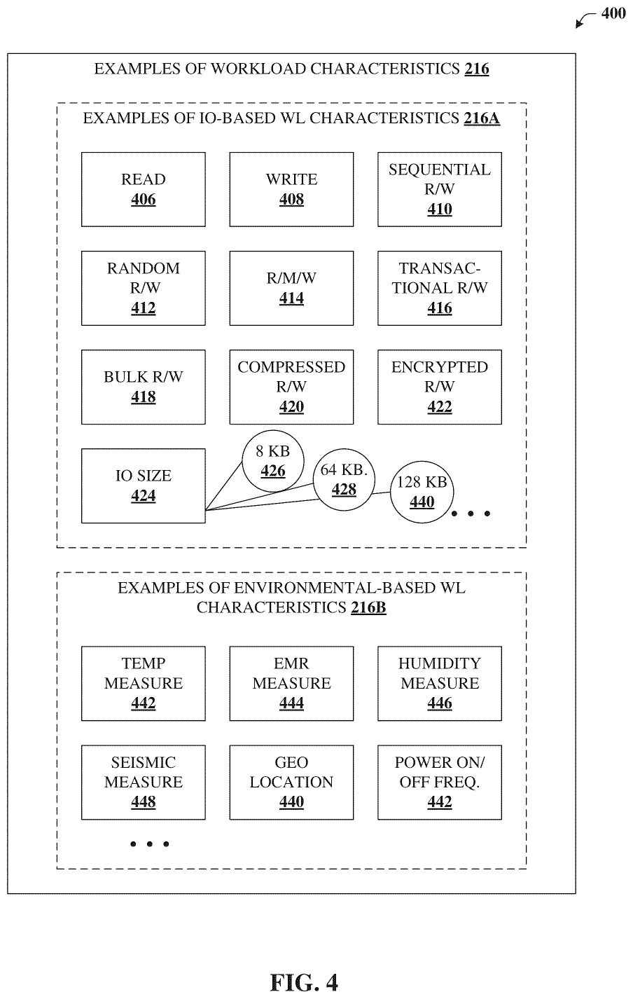

Service history data 214 can comprise one or more workload characteristics 216 for failed drive 212 and/or more generally for any drive 106 of storage array 102. In some embodiments, a given workload characteristic 216 can be derived from telemetry data 108 or other data included in telemetry data store 112. Additional detail relating to workload characteristics 216 can be found with reference to FIG. 4.

While still referring to FIG. 2, but turning now as well to FIGS. 3 and 4, additional detail can be provided. Referring specifically to FIG. 3, a tabular diagram 300 is depicted illustrating an example of service history data 214 that can be received from telemetry data store 112 in accordance with certain embodiments of this disclosure. In some embodiments, service history data 214 can be indicative of an aggregation of various IO transactions performed by a given drive 106 (e.g., failed drive 212) over the service life of drive 106. Such can include the number of reads performed by drive 106 (or specifically failed drive 212), the number of writes performed by drive 106, or another IO transaction performed by drive 106. Such can also include information relating to the type of IO transaction performed by drive 106 such as a number of IO transactions of a particular size and so on.

Service history data 214 can be indicative of any information that can be indicated by or derived from telemetry data 108 and/or information included in telemetry data store 112. In some embodiments, service history data 214 and/or telemetry data store 112 can further include environmental factors collected during operation such as a temperature (e.g., average, peak, . . . ) associated with operation of a given drive 106. Any information relating to the operation of drive 106 can be included in service history data 214 and can also be identified as a workload characteristic 216, which is further detailed in connection with FIG. 4.

With reference now to FIG. 4, a schematic block diagram 400 illustrating various examples of the workload characteristics 216 in accordance with certain embodiments of this disclosure. As illustrated, workload characteristics 216 can be IO-based workload characteristics 216A, environmental-based workload characteristics 216B, or another suitable type of workload characteristic. IO-based workload characteristics 216A can typically be received via telemetry data 108 or can be derived from telemetry data 108. Environmental-based workload characteristics 216B can be received or derived from telemetry data 108 but might also be received or derived from another source. Hence, information included in telemetry data store 112 is not limited to only information received via telemetry data 108.

With regard to IO-based workload characteristics 216A, such can relate to raw, aggregate or total number of certain IO transactions, a percentage of the total number of transactions, or another suitable metric. These IO transactions can classified as read 406 IO transactions, write 408 IO transactions, which can represent a generalized view of the various types of IO transactions.

Furthermore, the IO transactions can relate to very specific types of read 406 or write 408 transactions such as a sequential read/write (R/W) 410. A sequential read 410 can be a read 406 operation in which data is accessed in sequential order, typically from start to end. This type of access pattern can be common for tasks such as reading a file sequentially or scanning through a database table. A sequential write 410 can be a write 408 operation involving writing data to storage (e.g., drive 106) in sequential order, typically appending data to the end of a file or dataset. This type of access pattern can be common in tasks such as logging data or writing to a sequential data structure.

Another example IO-based workload characteristic 216A can relate to a random R/W 412. A random read 412 can be a read 406 operation involving accessing data in a non-sequential order, such as by jumping to specific locations within a file or dataset to retrieve data. Random reads 412 can be common in tasks such as searching for specific records in a database or accessing elements in a data array. A random write 412 can be a write 408 operation involving writing data to storage (e.g., drive 106) in a non-sequential order, such as updating or modifying specific locations within a file or dataset. Random writes 412 are common in tasks such as updating records in a database or modifying elements in a data array.

Another example IO-based workload characteristic 216A can relate to a read-modify-write (R/M/W) 414. Read-modify-write transactions typically involve reading data from storage, modifying it, and then writing it back to storage. This type of IO transaction can be common in tasks such as updating records or performing transactions in a database.

Still another example IO-based workload characteristic 216A can relate to a transactional R/W 416. Transactional reads and writes can involve performing a series of read 406 and write 408 operations as part of a transaction, ensuring atomicity, consistency, isolation, and durability of the transaction. Another example IO-based workload characteristic 216A can relate to a bulk R/W 418. Bulk reads and writes can involve reading or writing a large amount of data in a single operation, typically optimized for efficiency and performance. Bulk IO operations can be common in tasks such as data migration, data loading, or batch processing.

Other examples of IO-based workload characteristic 216A can relate to compressed R/W 420, in which a payload is compressed before being stored, encrypted R/W 422 in which a payload is encrypted before being stored, or any IO transaction that is classified by IO size 424. Examples can be an 8 kilobyte (KB) R/W 426, a 64 KB R/W 428, a 128 KB R/W 430, and so on.

With regard to environmental-based workload characteristic 216B, one example can be a temperature measure 442. Temperature measure 442, as well as other measures can relate to an ambient measurement or a device measurement during operation of drive 106. Such can relate to an average measure, a peak measure, or another suitable type of measure. In addition to temperature measure 442, other potential environmental-based workload characteristic 216B can be an electromagnetic radiation (EMR) measure 444, a humidity measure 446, a seismic measure 448, and so on.

Furthermore, environmental-based workload characteristic 216B can also relate to a geographic location 440 and/or a location or region in which drive 106 is situated. Different geographical locations 440 may have different regulations or customs that can be determined to affect the operation or durability/lifespan of certain drives 106. One such example can be power on/off frequency 442. For example, duc to a common practice in a particular geographical location 440 of shutting down storage arrays when not in use, associated drives 106 were witnessed to have a marked reduction in lifespan. However, certain drive types might be determined to be more/less durable under that particular condition (e.g., a workload profile), which can be a significant factor when recommending a replacement drive.

Still referring to FIG. 2, at reference numeral 215, based on service history data 214 for failed drive 212, device 200 can determine service classification 218. Service classification 218 can indicate one or more prominent workload characteristics 220 for failed drive 212, which is indicated at reference numeral 222. Thus, prominent workload characteristic 220 can be indicative of certain significant operating conditions for failed drive 212 under which failed drive 212 operated during an associated operational life. In other words, prominent workload characteristic 220 can be a prominent characteristic of the specific drive workload 110 of failed drive 212, which can be expected to exist for a replacement of failed drive 212.

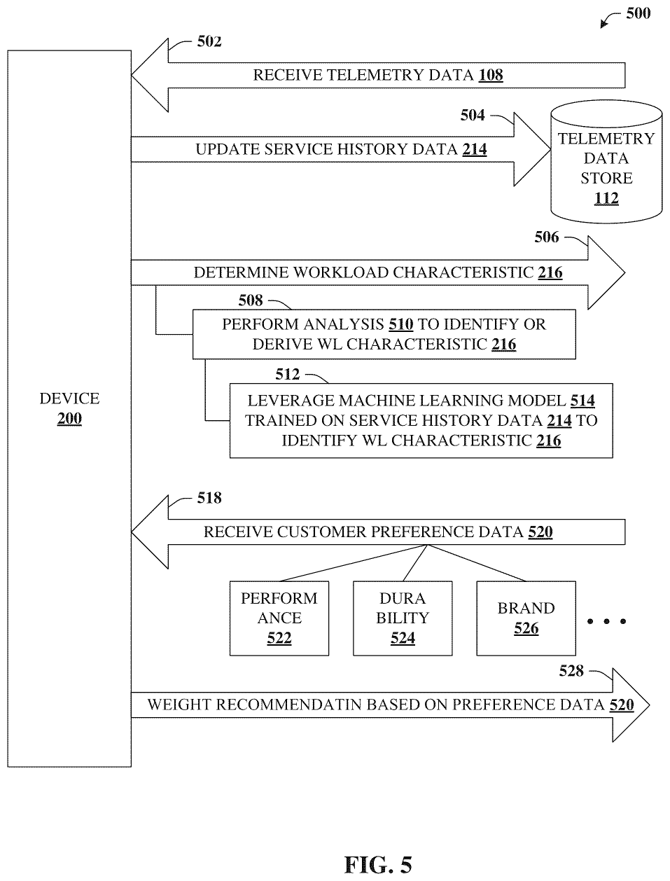

Prominent workload characteristic 220 can be selected from among workload characteristics 216, all or a portion of which can be related to workload elements or aspects that are determined to have an impact on the durability or lifespan of a given drive 106. In some embodiments, workload characteristics 216 can be determined by device 200, which is further detailed in connection with FIG. 5.

At reference numeral 224, device 200 can generate recommendation data 226. As indicated at reference numeral 228, recommendation data 226 can comprise a recommendation for replacement drive 230 that is to replace failed drive 212. Recommendation data 226 can be generated as a function of prominent workload characteristic 220. Thus, replacement drive 230 can be determined by, e.g., comparing the lifespan of many different drive types that operated under the condition(s) indicated by the prominent workload characteristic(s) 220.

For example, suppose a given storage array 102 tends to operate at a temperature (e.g., temperature measure 442) that is slightly higher than an average value and further suppose that 60% a given drive workload 110 for an associated failed drive 212 related to random reads 412 having an IO size 424 of 8 KB 426. In that case, temperature measure 442 and 8 KB random reads may be determined to be prominent workload characteristics 220, and replacement drive 230 can be specifically selected because replacement drive 230 has been determined to perform well versus peers when operating at higher than normal temperatures and/or when servicing 8 KB random reads as a high percentage relative to other types of IO transactions.

By way of example, as indicated at reference numeral 229, recommendation data 226 can include information such as a manufacturer identifier 230 that identifies a particular manufacturer for replacement drive 230, model identifier 232 that identifies the model of replacement drive 230, a drive size identifier 234 that identifies the size or capacity of replacement drive 230. In some embodiments, recommendation data 226 can further include a reason or description 236 for the particular recommendation, which may include prominent workload characteristics 220. For example, the recommendation can indicate that a given replacement drive 230 (e.g., identified via manufacturer ID 230, model ID 232, . . . ) can excel at operation under higher than normal temperatures and/or with small block burst workloads, either or both of which were observed to prominent for drive workload 110 of the failed drive 212.

With reference now to FIG. 5, a schematic block diagram 500 is depicted illustrating additional elements or aspect of the example device 200 that can generate the recommendation and can further determine the workload characteristics 216 in accordance with certain embodiments of this disclosure.

At reference numeral 502, device 200 can receive telemetry data 108. Such can include IO transactions associated with drives 16 as well as other data. In some embodiments, telemetry data 108 can be received from telemetry data store 112 or from drives 106 of storage array 102 or other storage arrays 114. In response to receiving telemetry data 108 and in particular based on telemetry data 108, at reference numeral 504, device 200 can update service history data 214, which in some embodiments, can be included in telemetry data store 112. For example, telemetry data 108 can be aggregated or transformed to associated fields or data structures of service history data 214.

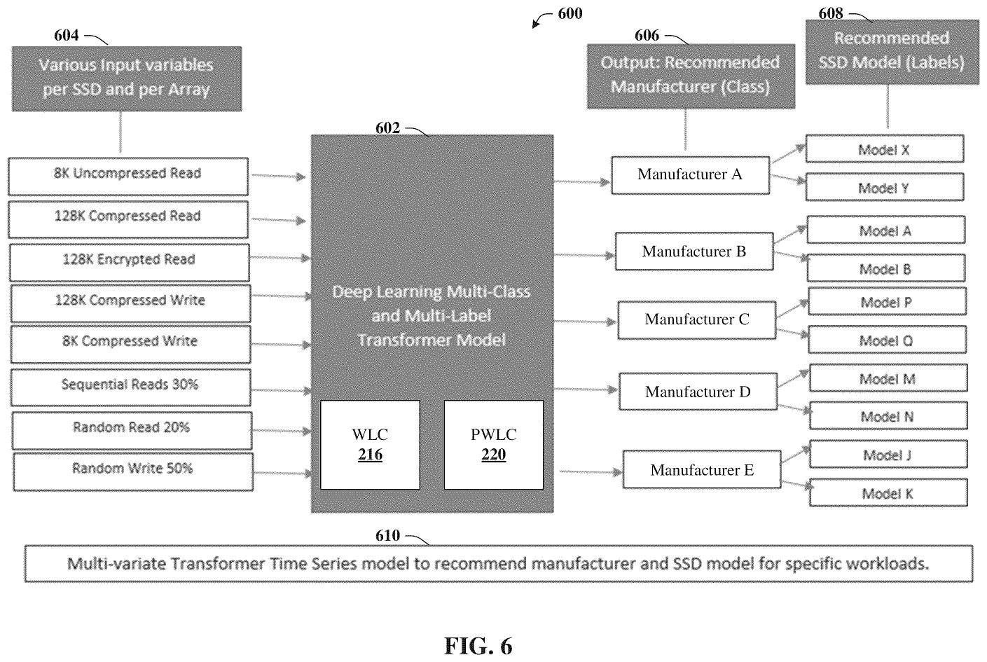

At reference numeral 506, device 200 can be configured to determine workload characteristics 216. Generally, as indicated at reference numeral 508, workload characteristics 216 can be determined in response to analysis 510. Analysis 510 can identify or derive (e.g., from telemetry data 108, service history data 214, or other data included in telemetry data store 112) workload characteristics 216. As indicated at reference numeral 512, analysis 510 can comprise using or leveraging a machine learning model 514 trained on service history data 214 to identify workload characteristics 216. An example illustration of such can be found with reference to FIG. 6.

With reference now to FIG. 6, a schematic block diagram 600 is depicted illustrating an example machine learning model that can determine or identify at least one of suitable workload characteristics 216, the prominent workload characteristics 220, or the recommendation data 226 in accordance with certain embodiments of this disclosure.

As illustrated, machine learning model 602 can be a deep learning multi-class and multi-label transformer model. As depicted at reference numeral 604, machine learning model 602 can be trained on various inputs such as telemetry data 108 or other suitable data. It is appreciated that such training data can be received from many thousands of drives 106 that span many different storage arrays 102. Such data can be collected over any suitable period.

In some embodiments, machine learning model 602 can determine various workload characteristics 216 such as those discussed in connection with FIG. 4, or others. Such determinations can be based on discovery of varying characteristics of different workloads and a potential to affect the lifespan of a given drive 106.

In some embodiments, machine learning model 602 can receive telemetry data 108 or other data formatted and/or aggregated specifically for certain workload characteristics 216 that are specific to a given drive 106 such as failed drive 212, or receive workload characteristics 216 relating to a given array 102. In response, machine learning model 602 can determine prominent workload characteristic 220, which can indicate one or more of the workload characteristics 216 that are significant to drive workload 110 of failed drive 212 or another drive 106 of the associated storage array 102.

In some embodiments, as indicated at reference numerals 606, 608, and 610, machine learning model 602 can further provide as output all or a portion of recommendation data 226, which can include manufacturer identifier 230, model identifier 232, or other suitable information. While machine learning model 602 is illustrated in the context of SSD drives 106, it is appreciated that the same or a different machine learning model 602 can operate in the context of HDD drives 106, or in the context of a hybrid storage array that comprises both SSD and HDD drives 106.

TABLE I

| Manufacturer | Model | Excels at Workload Type (e.g., prominent WLC 220) |
|---|---|---|
| MFR 1 | A | Large and heavy workloads. |
| MFR 1 | B | Large and heavy workloads. Withstands heat. |
| MFR 1 | C | Large encrypted workloads |
| MFR 2 | A | Small block burst workloads |
| MFR 3 | A | Small block compressed writes workloads |
| MFR 4 | A | Large compression workloads |
| MFR 4 | B | Large block Heavy compressed workloads |
| MFR 5 | A | Uncompressed reads and writes workloads |
| MFR 6 | A | Light compressed workloads |

Table I above provides an example of various different drive 106 types (e.g., manufacturer and model) and associated workload types in which that particular drive excels. Hence, upon a determination that failed drive 212 had a specific drive workload 110 with an associated prominent workload characteristic 220, an associated replacement drive 230 can be selected to excel under conditions associated with the same or similar prominent workload characteristic 230.

Turning back to FIG. 5, at reference numeral 518, device 200 can receive customer preference data 520. Customer preference data 520 can relate to one or more preferences for replacement drive 230 or another drive that is to be added to storage array 102. Examples of customer preference data 520 can be a preference for performance 522, a preference for durability 524, a preference for a particular brand 526, and so on. At reference numeral 528, device 200 can weight the recommendation of recommendation data 226 based on preference data 520.

While a typical storage array provider/vendor 110 will typically only use drives 106 that have been tested and certified to meet certain threshold metrics relating to performance and durability metrics, the various certified drives 106 can still exhibit differences with regard to those metrics which can be identified. For example, drive model A may be determined to have better throughput or latency than drive model B (even though both meet associated threshold ratings). However, drive model B may be determined to have better durability, particularly when operating at above normal temperatures measures 442, and still performs better than threshold ratings.

In this scenario, recommendation data 226 may select drive model B as the replacement drive due to the improved durability metric. However, if customer preference data 520 indicates a strong preference for performance 522 over durability 524 for a particular drive 106, server device 104, or storage array 102, than such can be taken into account by a weighting procedure. In some cases, the result may be to recommend drive A instead due to customer preference data 520.

As another example, suppose drive A and drive B both have superior performance and durability metrics under the potentially unique drive workload 110 that was identified for failed drive 212. Hence, either one might be recommended. Customer preference data 520 indicates a customer preference for the brand (e.g., manufacturer) of drive A. As such, recommendation data 226 can weight the recommendation to selected drive A over drive B.

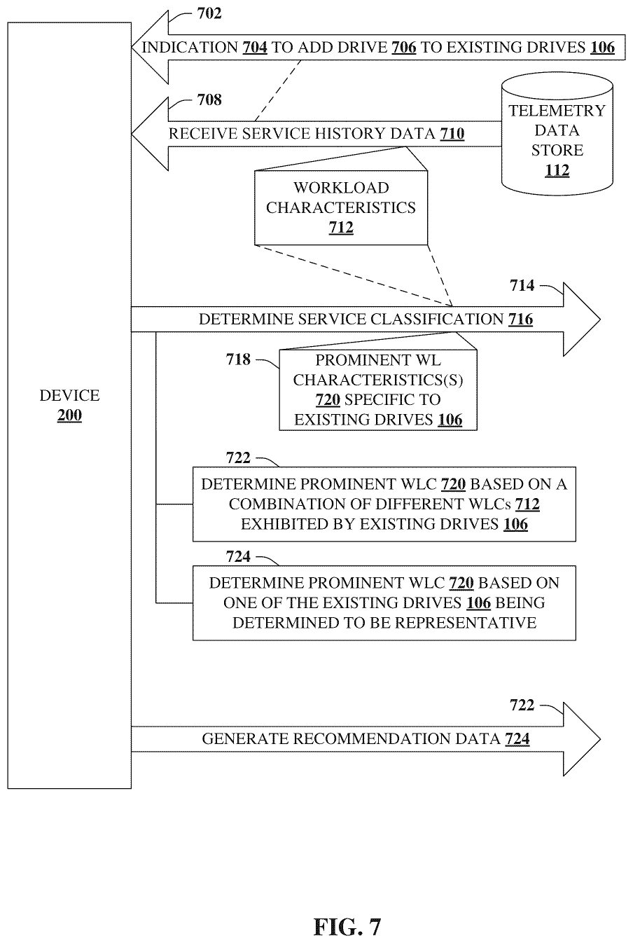

With reference now to FIG. 7, a schematic block diagram 700 is depicted illustrating the example device generating a recommendation for a new drive to be added to a storage array based on workload characteristics of the storage array in accordance with certain embodiments of this disclosure.

At reference numeral 702, device 200 can receive indication 704. Indication 704 can be similar to indication 210 of FIG. 2, but in this case, indication 704 indicates that at least one new drive 706 is to be added to storage array 102. Such can be the result of an expansion of existing drives 106 of storage array 102 and not necessarily due to the failure of one of the existing drives 106.

Because new drive 706 is not necessarily a replacement drive 230, there exist scenarios in which new drive 706 will not be associated with a known drive workload 110 as was the case with failed drive 212. In these and other suitable scenarios, at reference numeral 708, device 200 can receive service history data 710, for example, from telemetry data store 112. Service history data 710 can comprise workload characteristics 712 for existing drives 106. Workload characteristics 712 can be similar to workload characteristics 216, but rather than being specific to a failed drive 212 as in some embodiments, in this scenario, workload characteristics 712 can be specific to the entire storage array 102 or some suitable portion of storage array 102.

At reference numeral 714, based on service history data 710, device 200 can determine service classification 716, which can be similar to service classification 218. For instance, as indicated at reference numeral 718, service classification 716 can comprise one or more prominent workload characteristics 720 that can be selected from among workload characteristics 712. Prominent workload characteristic 720 can be specific to existing drives 106 and can be specific to or based on any suitable workload profile.

For example, at reference numeral 722, prominent workload characteristic 720 can be determined based on a combination of different workload characteristics 712 exhibited by one or more existing drives 106. At reference numeral 724, prominent workload characteristic 720 can be determined based on one the existing drives 106 being determined to be representative. In this later case, in which one of the existing drives 106 is determined to be representative of an expected workload for new drive 706, such can be similar to the case in which replacement drive 230 is recommended for a failed drive 212.

Regardless of the particular technique being used, at reference numeral 722, device 200 can generate recommendation data 724 that can be substantially similar to recommendation data 226 detailed in connection with FIG. 2. Hence, recommendation data 724 can comprise information such as manufacturer identifier 230, model identifier 232, drive size identifier 234, reason/description 236, prominent workload characteristic 720, and so on.

### Example Methods

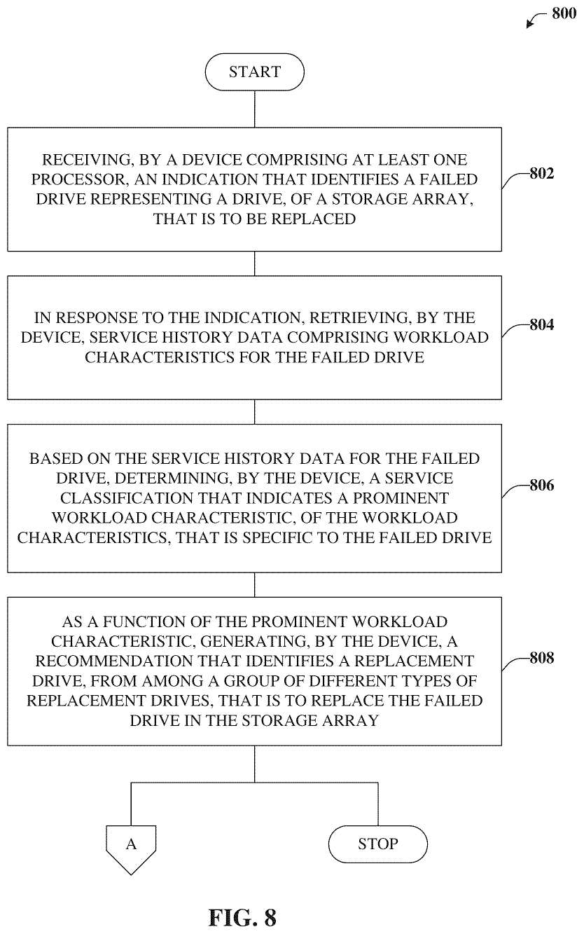

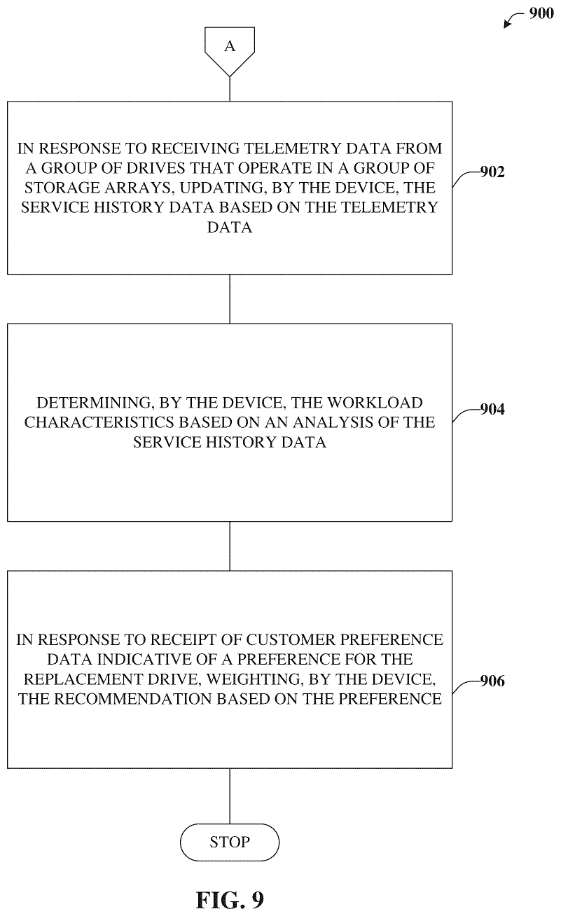

FIGS. 8 and 9 illustrate various methods in accordance with the disclosed subject matter. While, for purposes of simplicity of explanation, the methods are shown and described as a series of acts, it is to be understood and appreciated that the disclosed subject matter is not limited by the order of acts, as some acts may occur in different orders and/or concurrently with other acts from that shown and described herein. For example, those skilled in the art will understand and appreciate that a method could alternatively be represented as a series of interrelated states or events, such as in a state diagram. Moreover, not all illustrated acts may be required to implement a method in accordance with the disclosed subject matter. Additionally, it should be further appreciated that the methods disclosed hereinafter and throughout this specification are capable of being stored on an article of manufacture to facilitate transporting and transferring such methods to computers.

Turning now to FIG. 8, exemplary method 800 is depicted. Method 800 can generate a recommendation for a replacement drive to replace a failed drive of a storage array based on workload characteristics of the failed drive in accordance with certain embodiments of this disclosure. While method 800 describes a complete method, in some embodiments, method 800 can include one or more elements of method 900, reached via insert A, as discussed at FIG. 9.

At reference numeral 802, a device comprising at least one processor can receive an indication that identifies a failed drive representing a drive, of a storage array, that is to be replaced. In other embodiments, the indication can instead indicate that one or more drives are to be added to the storage array. Thus, whether the storage array is being expanded or a failed drive is being replaced, the device can accommodate both scenarios.

At reference numeral 804, in response to the indication, the device can retrieve service history data, for example, from a telemetry data store or another suitable data store or device. Service history data can comprise various workload characteristics for the failed drive and/or for the associated storage array or components thereof.

At reference numeral 806, based on the service history data (e.g., for the failed drive or otherwise), the device can determine a service classification for the failed drive. For instance, the service classification can indicate a prominent workload characteristic, of the workload characteristics, that is specific to the failed drive.

At reference numeral 808, as a function of the prominent workload characteristic, generating, by the device, a recommendation that identifies a replacement drive that is to replace the failed drive in the storage array. The replacement drive can be identified from among a group of different types of replacement drives. Method 800 can terminate in some embodiments, or proceed to insert A in other embodiments, which are further detailed in connection with FIG. 9.

Turning now to FIG. 9, exemplary method 900 is depicted. Method 900 can provide for additional elements or functionality relating to generating the recommendation for a replacement drive to replace a failed drive of a storage array based on workload characteristics of the failed drive in accordance with certain embodiments of this disclosure.

For example, at reference numeral 902, the device introduced in connection with FIG. 8 can, in response to receiving telemetry data from a group of drives that operate in a group of storage arrays, update the service history data based on the telemetry data. For example, additional telemetry data can be combined with other telemetry data to provide updated information.

A reference numeral 904, the device can determine the workload characteristics based on an analysis of the service history data. A reference numeral 906, in response in response to receipt of customer preference data indicative of a preference for the replacement drive, the device can weight the recommendation based on the preference.

### Example Operating Environments

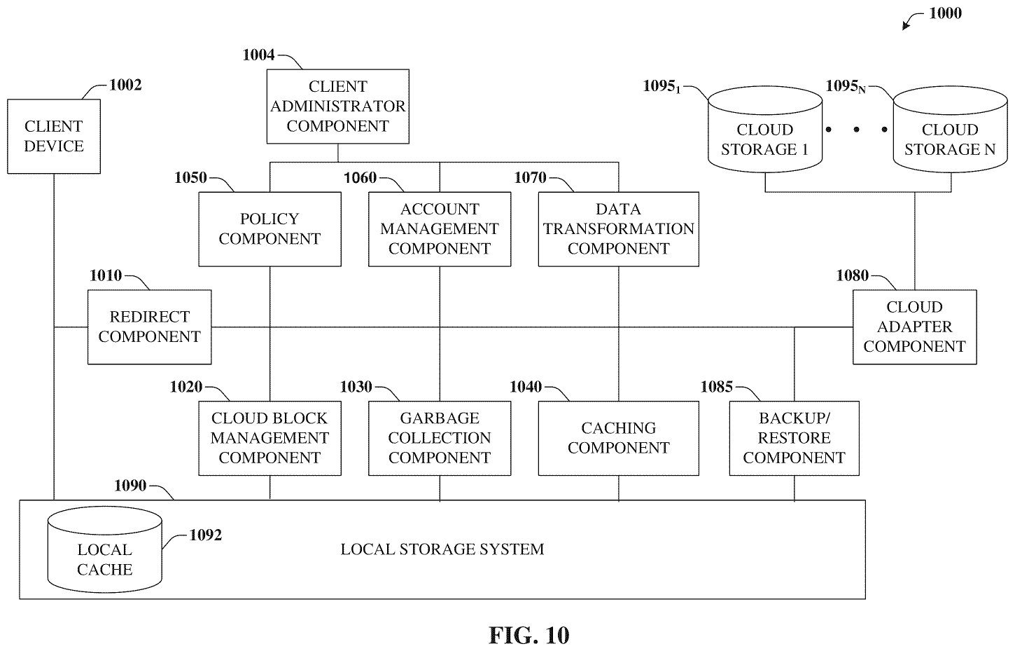

To provide further context for various example embodiments of the subject specification, FIGS. 10 and 11 illustrate, respectively, a block diagram of an example distributed file storage system 1000 that employs tiered cloud storage and block diagram of a computer 1102 operable to execute the disclosed storage architecture in accordance with example embodiments described herein.

Referring now to FIG. 10, there is illustrated an example local storage system including cloud tiering components and a cloud storage location in accordance with implementations of this disclosure. Client device 1002 can access local storage system 1090. Local storage system 1090 can be a node and cluster storage system such as an EMC Isilon Cluster that operates under OneFS operating system. Local storage system 1090 can also store the local cache 1092 for access by other components. It can be appreciated that the systems and methods described herein can run in tandem with other local storage systems as well.

As more fully described below with respect to redirect component 1010, redirect component 1010 can intercept operations directed to stub files. Cloud block management component 1020, garbage collection component 1030, and caching component 1040 may also be in communication with local storage system 1090 directly as depicted in FIG. 10 or through redirect component 1010. A client administrator component 1004 may use an interface to access the policy component 1050 and the account management component 1060 for operations as more fully described below with respect to these components. Data transformation component 1070 can operate to provide encryption and compression to files tiered to cloud storage. Cloud adapter component 1080 can be in communication with cloud storage 1 10951 and cloud storage N 1095x, where N is a positive integer. It can be appreciated that multiple cloud storage locations can be used for storage including multiple accounts within a single cloud storage location as more fully described in implementations of this disclosure. Further, a backup/restore component 1085 can be utilized to back up the files stored within the local storage system 1090.

Cloud block management component 1020 manages the mapping between stub files and cloud objects, the allocation of cloud objects for stubbing, and locating cloud objects for recall and/or reads and writes. It can be appreciated that as file content data is moved to cloud storage, metadata relating to the file, for example, the complete inode and extended attributes of the file, still are stored locally, as a stub. In one implementation, metadata relating to the file can also be stored in cloud storage for use, for example, in a disaster recovery scenario.

Mapping between a stub file and a set of cloud objects models the link between a local file (e.g., a file location, offset, range, etc.) and a set of cloud objects where individual cloud objects can be defined by at least an account, a container, and an object identifier. The mapping information (e.g., mapinfo) can be stored as an extended attribute directly in the file. It can be appreciated that in some operating system environments, the extended attribute field can have size limitations. For example, in one implementation, the extended attribute for a file is 8 kilobytes. In one implementation, when the mapping information grows larger than the extended attribute field provides, overflow mapping information can be stored in a separate system b-tree. For example, when a stub file is modified in different parts of the file, and the changes are written back in different times, the mapping associated with the file may grow. It can be appreciated that having to reference a set of non-sequential cloud objects that have individual mapping information rather than referencing a set of sequential cloud objects, can increase the size of the mapping information stored. In one implementation, the use of the overflow system b-tree can limit the use of the overflow to large stub files that are modified in different regions of the file.

File content can be mapped by the cloud block management component 1020 in chunks of data. A uniform chunk size can be selected where all files that are tiered to cloud storage can be broken down into chunks and stored as individual cloud objects per chunk. It can be appreciated that a large chunk size can reduce the number of objects used to represent a file in cloud storage; however, a large chunk size can decrease the performance of random writes.

The account management component 1060 manages the information for cloud storage accounts. Account information can be populated manually via a user interface provided to a user or administrator of the system. Each account can be associated with account details such as an account name, a cloud storage provider, a uniform resource locator (“URL”), an access key, a creation date, statistics associated with usage of the account, an account capacity, and an amount of available capacity. Statistics associated with usage of the account can be updated by the cloud block management component 1020 based on a list of mappings that the cloud block management component 1020 manages. For example, each stub can be associated with an account, and the cloud block management component 1020 can aggregate information from a set of stubs associated with the same account. Other example statistics that can be maintained include the number of recalls, the number of writes, the number of modifications, and the largest recall by read and write operations, etc. In one implementation, multiple accounts can exist for a single cloud service provider, each with unique account names and access codes.

The cloud adapter component 1080 manages the sending and receiving of data to and from the cloud service providers. The cloud adapter component 1080 can utilize a set of APIs. For example, each cloud service provider may have provider specific API to interact with the provider.

A policy component 1050 enables a set of policies that aid a user of the system to identify files eligible for being tiered to cloud storage. A policy can use criteria such as file name, file path, file size, file attributes including user generated file attributes, last modified time, last access time, last status change, and file ownership. It can be appreciated that other file attributes not given as examples can be used to establish tiering policies, including custom attributes specifically designed for such purpose. In one implementation, a policy can be established based on a file being greater than a file size threshold and the last access time being greater than a time threshold.

In one implementation, a policy can specify the following criteria: stubbing criteria, cloud account priorities, encryption options, compression options, caching and IO access pattern recognition, and retention settings. For example, user selected retention policies can be honored by garbage collection component 1030. In another example, caching policies such as those that direct the amount of data cached for a stub (e.g., full vs. partial cache), a cache expiration period (e.g., a time period where after expiration, data in the cache is no longer valid), a write back settle time (e.g., a time period of delay for further operations on a cache region to guarantee any previous writebacks to cloud storage have settled prior to modifying data in the local cache), a delayed invalidation period (e.g., a time period specifying a delay until a cached region is invalidated thus retaining data for backup or emergency retention), a garbage collection retention period, backup retention periods including short term and long term retention periods, etc.

A garbage collection component 1030 can be used to determine which files/objects/data constructs remaining in both local storage and cloud storage can be deleted. In one implementation, the resources to be managed for garbage collection include CMOs, cloud data objects (CDOs) (e.g., a cloud object containing the actual tiered content data), local cache data, and cache state information.

A caching component 1040 can be used to facilitate efficient caching of data to help reduce the bandwidth cost of repeated reads and writes to the same portion (e.g., chunk or sub-chunk) of a stubbed file, can increase the performance of the write operation, and can increase performance of read operations to portion of a stubbed file accessed repeatedly. As stated above with regards to the cloud block management component 1020, files that are tiered are split into chunks and in some implementations, sub chunks. Thus, a stub file or a secondary data structure can be maintained to store states of each chunk or sub-chunk of a stubbed file. States (e.g., stored in the stub as cacheinfo) can include a cached data state meaning that an exact copy of the data in cloud storage is stored in local cache storage, a non-cached state meaning that the data for a chunk or over a range of chunks and/or sub chunks is not cached and therefore the data has to be obtained from the cloud storage provider, a modified state or dirty state meaning that the data in the range has been modified, but the modified data has not yet been synched to cloud storage, a sync-in-progress state that indicates that the dirty data within the cache is in the process of being synced back to the cloud and a truncated state meaning that the data in the range has been explicitly truncated by a user. In one implementation, a fully cached state can be flagged in the stub associated with the file signifying that all data associated with the stub is present in local storage. This flag can occur outside the cache tracking tree in the stub file (e.g., stored in the stub file as cacheinfo), and can allow, in one example, reads to be directly served locally without looking to the cache tracking trec.

The caching component 1040 can be used to perform at least the following seven operations: cache initialization, cache destruction, removing cached data, adding existing file information to the cache, adding new file information to the cache, reading information from the cache, updating existing file information to the cache, and truncating the cache due to a file operation. It can be appreciated that besides the initialization and destruction of the cache, the remaining five operations can be represented by four basic file system operations: Fill, Write, Clear and Sync. For example, removing cached data is represented by clear, adding existing file information to the cache by fill, adding new information to the cache by write, reading information from the cache by read following a fill, updating existing file information to the cache by fill followed by a write, and truncating cache due to file operation by sync and then a partial clear.

In one implementation, the caching component 1040 can track any operations performed on the cache. For example, any operation touching the cache can be added to a queue prior to the corresponding operation being performed on the cache. For example, before a fill operation, an entry is placed on an invalidate queue as the file and/or regions of the file will be transitioning from an uncached state to cached state. In another example, before a write operation, an entry is placed on a synchronization list as the file and/or regions of the file will be transitioning from cached to cached-dirty. A flag can be associated with the file and/or regions of the file to show that the file has been placed in a queue and the flag can be cleared upon successfully completing the queue process.

In one implementation, a time stamp can be utilized for an operation along with a custom settle time depending on the operations. The settle time can instruct the system how long to wait before allowing a second operation on a file and/or file region. For example, if the file is written to cache and a write back entry is also received, by using settle times, the write back can be re-queued rather than processed if the operation is attempted to be performed prior to the expiration of the settle time.

In one implementation, a cache tracking file can be generated and associated with a stub file at the time the stub file is tiered to the cloud. The cache tracking file can track locks on the entire file and/or regions of the file and the cache state of regions of the file. In one implementation, the cache tracking file is stored in an Alternate Data Stream (“ADS”). It can be appreciated that ADS are based on the New Technology File System (“NTFS”) ADS. In one implementation, the cache tracking tree tracks file regions of the stub file, cached states associated with regions of the stub file, a set of cache flags, a version, a file size, a region size, a data offset, a last region, and a range map.

In one implementation, a cache fill operation can be processed by the following steps: (1) an exclusive lock on can be activated on the cache tracking tree; (2) it can be verified whether the regions to be filled are dirty; (3) the exclusive lock on the cache tracking tree can be downgraded to a shared lock; (4) a shared lock can be activated for the cache region; (5) data can be read from the cloud into the cache region; (6) update the cache state for the cache region to cached; and (7) locks can be released.

In one implementation, a cache read operation can be processed by the following steps: (1) a shared lock on the cache tracking tree can be activated; (2) a shared lock on the cache region for the read can be activated; (3) the cache tracking tree can be used to verify that the cache state for the cache region is not “not cached;” (4) data can be read from the cache region; (5) the shared lock on the cache region can be deactivated; (6) the shared lock on the cache tracking tree can be deactivated.

In one implementation, a cache write operation can be processed by the following steps: (1) an exclusive lock on can be activated on the cache tracking tree; (2) the file can be added to the synch queue; (3) if the file size of the write is greater than the current file size, the cache range for the file can be extended; (4) the exclusive lock on the cache tracking tree can be downgraded to a shared lock; (5) an exclusive lock can be activated on the cache region; (6) if the cache tracking tree marks the cache region as “not cached” the region can be filled; (7) the cache tracking tree can updated to mark the cache region as dirty; (8) the data can be written to the cache region; (9) the lock can be deactivated.

In one implementation, data can be cached at the time of a first read. For example, if the state associated with the data range called for in a read operation is non-cached, then this would be deemed a first read, and the data can be retrieved from the cloud storage provider and stored into local cache. In one implementation, a policy can be established for populating the cache with range of data based on how frequently the data range is read; thus, increasing the likelihood that a read request will be associated with a data range in a cached data state. It can be appreciated that limits on the size of the cache, and the amount of data in the cache can be limiting factors in the amount of data populated in the cache via policy.

A data transformation component 1070 can encrypt and/or compress data that is tiered to cloud storage. In relation to encryption, it can be appreciated that when data is stored in off-premises cloud storage and/or public cloud storage, users can request or require data encryption to ensure data is not disclosed to an illegitimate third party. In one implementation, data can be encrypted locally before storing/writing the data to cloud storage.

In one implementation, the backup/restore component 1085 can transfer a copy of the files within the local storage system 1090 to another cluster (e.g., target cluster). Further, the backup/restore component 1085 can manage synchronization between the local storage system 1090 and the other cluster, such that, the other cluster is timely updated with new and/or modified content within the local storage system 1090.

In order to provide additional context for various embodiments described herein, FIG. 11 and the following discussion are intended to provide a brief, general description of a suitable computing environment 1100 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

In order to provide additional context for various embodiments described herein, FIG. 11 and the following discussion are intended to provide a brief, general description of a suitable computing environment 1100 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the example environment 1100 for implementing various example embodiments described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a non-volatile memory such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), one or more external storage devices 1116 (e.g., a magnetic floppy disk drive (FDD) 1116, a memory stick or flash drive reader, a memory card reader, etc.) and an optical disk drive 1120 (e.g., which can read or write from a CD-ROM disc, a DVD, a BD, etc.). While the internal HDD 1114 is illustrated as located within the computer 1102, the internal HDD 1114 can also be configured for external use in a suitable chassis (not shown). Additionally, while not shown in environment 1100, a solid state drive (SSD) could be used in addition to, or in place of, an HDD 1114. The HDD 1114, external storage device(s) 1116 and optical disk drive 1120 can be connected to the system bus 1108 by an HDD interface 1124, an external storage interface 1126 and an optical drive interface 1128, respectively. The interface 1124 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (VM) of multiple VMs hosted at computer 1102. Furthermore, operating system 1130 can provide runtime environments, such as the Java runtime environment or the .NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1394 serial port, a game port, a USB port, an IR interface, a BLUETOOTH® interface, etc.

A monitor 1146 or other type of display device can be also connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the Internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are examples and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1126 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 5 GHz radio band at a 54 Mbps (802.11a) data rate, and/or a 2.4 GHz radio band at an 11 Mbps (802.11b), a 54 Mbps (802.11g) data rate, or up to a 600 Mbps (802.11n) data rate for example, or with products that contain both bands (dual band), so the networks can provide real-world performance similar to the basic “10BaseT” wired Ethernet networks used in many offices.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. In an example embodiment, when a processor executes instructions to perform “operations”, this could include the processor performing the operations directly and/or facilitating, directing, or cooperating with another device or component to perform the operations.

In the subject specification, terms such as “data store,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or API components.

Further, the various embodiments can be implemented as a method, apparatus, or article of manufacture using standard programming and/or engineering techniques to produce software, firmware, hardware, or any combination thereof to control a computer to implement one or more example embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A device, comprising:
at least one processor; and
at least one memory that stores executable instructions that, when executed by the at least one processor, facilitate performance of operations, comprising:
in response to an indication that identifies a failed drive representing a drive, of a storage array, that is to be replaced, receiving service history data comprising workload characteristics for the failed drive;
based on the service history data for the failed drive, determining a service classification that indicates a prominent workload characteristic, of the workload characteristics, that is specific to the failed drive; and
as a function of the prominent workload characteristic, generating recommendation data representative of a recommendation that identifies a replacement drive, from among a group of different types of replacement drives, that is to replace the failed drive in the storage array.

2. The device of claim 1, wherein the prominent workload characteristic is at least one first member of a group of different types of input/output (IO) transactions served by the failed drive during historical operation within the storage array, or at least one second member of a group of different environmental conditions under which the failed drive historically operated within the storage array.

3. The device of claim 2, wherein the group of different types of IO transactions comprises at least one of: a read IO transaction, a write IO transaction, a sequential read/write IO transaction, a random read/write IO transaction, a read-modify-write IO transaction, a transactional read/write IO transaction, a bulk read/write IO transaction, a compressed read/write IO transaction, an encrypted read/write IO transaction, or an IO transaction of a specific IO size, wherein the specific IO size is at least one of 8 kilobytes, 64 kilobytes, or 128 kilobytes.

4. The device of claim 2, wherein the group of different environmental conditions comprises at least one of: a temperature measure, an electromagnetic radiation measure, a humidity measure, a seismic measure, a geographical location, or a power on/off frequency.

5. The device of claim 1, wherein the operations further comprise, in response to receiving telemetry data from a group of drives that operate in a group of storage arrays, updating, based on the telemetry data, the service history data.

6. The device of claim 5, wherein the operations further comprise determining the workload characteristics based on an analysis of the service history data.

7. The device of claim 6, wherein the analysis comprises using a machine learning model trained on the service history data to identify the workload characteristics in response to a deep learning multi-class and multi-label time-series transformer model.

8. The device of claim 1, wherein the operations further comprise:
receiving customer preference data indicative of a preference for the replacement drive; and
weighting the recommendation based on the preference.

9. A device, comprising:
at least one processor; and
at least one memory that stores executable instructions that, when executed by the at least one processor, facilitate performance of operations, comprising:
in response to an indication that at least one drive is to be installed in a storage array comprising existing drives, receiving service history data comprising workload characteristics for the existing drives;
based on the service history data for the existing drives, determining a service classification that indicates a prominent workload characteristic, from among the workload characteristics, that is specific to the storage array; and
as a function of the prominent workload characteristic, generating recommendation data representative of a recommendation for the at least one drive, from among a group of different types of available drives, that is to be installed in the storage array.

10. The device of claim 9, wherein the indication occurs as a result of a failure associated with one of the existing drives.

11. The device of claim 9, wherein the indication occurs as a result of the storage array being expanded by the addition of the at least one drive.

12. The device of claim 9, wherein the prominent workload characteristic is at least one first member of a group of different types of input/output (IO) transactions served by the existing drives during historical operation within the storage array, or at least one second member of a group of different environmental conditions under which the existing drives historically operated within the storage array.

13. The device of claim 9, wherein the prominent workload characteristic is determined based on a combination of different workload characteristics exhibited by individual ones of the existing drives.

14. The device of claim 9, wherein the prominent workload characteristic is determined based on a selection of one or more of the existing drives as being representative, and wherein the prominent workload characteristic is specific to the one or more existing drives determined to be representative.

15. The device of claim 9, wherein the operations further comprise, in response to receiving telemetry data from a group of drives that operate in a group of storage arrays, updating, based on the telemetry data, the service history data.

16. The device of claim 15, wherein the operations further comprise determining the workload characteristics based on an analysis of the service history data.

17. A method, comprising:
receiving, by a device comprising at least one processor, an indication that identifies a failed drive representing a drive, of a storage array, that is to be replaced;
in response to the indication, retrieving, by the device, service history data comprising workload characteristics for the failed drive;
based on the service history data for the failed drive, determining, by the device, a service classification that indicates a prominent workload characteristic, of the workload characteristics, that is specific to the failed drive; and
as a function of the prominent workload characteristic, generating, by the device, a recommendation that identifies a replacement drive, from among a group of different types of replacement drives, that is to replace the failed drive in the storage array.

18. The method of claim 17, further comprising, in response to receiving telemetry data from a group of drives that operate in a group of storage arrays, updating, by the device, the service history data based on the telemetry data.

19. The method of claim 17, further comprising determining, by the device, the workload characteristics based on an analysis of the service history data.

20. The method of claim 17, further comprising, in response to receipt of customer preference data indicative of a preference for the replacement drive, weighting, by the device, the recommendation based on the preference.
